(19) United States
(12) Patent Application Publication
(10) Pub. No.: US 2023/0395301 A1
(43) Pub. Date: Dec. 7, 2023

(54) WOUND CORE

(71) Applicant: JFE Steel Corporation, Tokyo (JP)

(72) Inventors: Takeshi Omura, Chiyoda-ku, Tokyo (JP); Hirotaka Inoue, Chiyoda-ku, Tokyo (JP); Kunihiro Senda, Chiyoda-ku, Tokyo (JP)

(73) Assignee: JFE Steel Corporation, Tokyo (JP)

(21) Appl. No.: 18/032,424

(22) PCT Filed: Sep. 2, 2021
(86) PCT No.: PCT/JP2021/032260

§ 371 Date: Apr. 18, 2023

(30) Foreign Application Priority Data
Nov. 13, 2020 (JP) 2020-189125

(51) Int. Cl. H01F 27/245

(52) U.S. Cl. CPC H01F 27/2455

(57) ABSTRACT

Provided is a wound core having a flat portion and corner portions adjacent to the flat portion, the flat portion including a lap portion, the corner portions including bent portions. A non-heat-resistant magnetic domain refined material is used for at least a part of the materials forming the wound core. Closure domains are formed in the non-heat-resistant magnetic domain refined material so as to extend in a direction intersecting a longitudinal direction of the non-heat-resistant magnetic domain refined material, an area of each of the closure domains in a cross section that is taken in the longitudinal direction being more than 7500 μm². In the lap portion, the ratio of the number of lap joint portions having a lap length of from 3.0 mm to 30 mm to the total number of lap joint portions is 50% or more.

### CROSS REFERENCE TO RELATED APPLICATIONS

This is the U.S. National Phase application of PCT/JP2021/032260, filed Sep. 2, 2021, which claims priority to Japanese Patent Application No. 2020-189125, filed Nov. 13, 2020, the disclosures of these applications being incorporated herein by reference in their entireties.

### FIELD OF THE INVENTION

The present invention relates to wound cores and particularly to a wound core produced using a non-heat-resistant magnetic domain refined material as a raw material.

### BACKGROUND OF THE INVENTION

One method for reducing losses in a transformer is to improve the magnetic properties of grain-oriented electrical steel sheets used for the core of the transformer. Examples of highly effective means for improving the magnetic properties include magnetic domain refining treatment (heat-resistant type) in which grooves are formed on the surfaces of the steel sheets using a roller having projections or electrolytic etching and magnetic domain refining treatment (non-heat-resistant type) in which microstrain is introduced by laser beam, electron beam, or plasma irradiation. Hereinafter, a core material subjected to magnetic domain refining treatment in which grooves are physically formed on the surface using a roller having projections or electrolytic etching is referred to as a “heat-resistant magnetic domain refined material.” A core material subjected to magnetic domain refining treatment in which strain is introduced into the surface using laser beam, electron beam, or plasma irradiation etc. is referred to as a “non-heat-resistant magnetic domain refined material” or a “strain-introduced magnetic domain refined material.”

Cores are classified into stacked-type cores (stacked cores) and wound-type cores (wound cores). Generally, a wound-type core as a whole is subjected to bending into a prescribed shape. After the entire core is subjected to bending, the core is subjected to shape correction and then subjected to strain relief annealing in order to relieve the strain introduced into the entire core. Therefore, in the case of non-heat-resistant magnetic domain refined materials with microstrain introduced thereinto, the microstrain is also removed during the strain relief annealing, so that the iron loss reducing effect is not obtained. Thus, heat-resistant magnetic domain refined materials having grooves physically formed therein have been used as core materials of wound cores to be subjected to strain relief annealing.

However, in unicore and duocore type wound cores, strain is introduced only into bent portions in corner portions, and the ratio of the volume of these regions to the total volume of the wound core is small, so that almost no iron loss deterioration occurs even when the strain relief annealing is not performed. Therefore, in the unicore and duocore type wound cores, even when a non-heat-resistant magnetic domain refined material with microstrain introduced thereinto is used to form the wound core, a significant reduction in iron loss can be expected.

For example, Patent Literature 1 discloses a technique in which a magnetic domain refined material with microstrain introduced thereinto is used for a unicore. This technique aims to reduce losses in the core by controlling a radius of curvature of bent portions, a width and a depth of closure domains in the microstrained portions, and a spacing of introducing microstrains. Patent Literature 2 discloses a technique for reducing losses in a core by controlling an amount of twin crystals introduced into bent portions. The use of one or a combination of two or more of conventional techniques can provide some degree of iron loss reducing effect. However, with these conventional techniques, the iron loss reducing effect may be insufficient, or the iron loss improving effect may be unsteady (the iron loss may or may not be improved). Therefore, at present, there is still a need for a novel loss-reduction technique.

### PATENT LITERATURE

PTL 1: Japanese Unexamined Patent Application Publication No. 2018-148036
PTL 2: International Publication No. WO2018/131613

### SUMMARY OF THE INVENTION

Aspects of the present invention have been made in view of the foregoing circumstances, and it is an object to provide a wound core that uses a non-heat-resistant magnetic domain refined material for at least a part of materials forming the wound core and has an improved iron loss reducing effect.

One of the causes of the increase in loss (iron loss) in a wound core is interlaminar magnetic flux transfer in an out-of-plane direction that occurs in a lap portion of the wound core. The direction of the interlaminar magnetic flux transfer differs significantly from the axis of easy magnetization, so that a large increase in iron loss occurs. This interlaminar magnetic flux transfer direction causes deterioration in the uniformity of the magnetic field distribution and leads to an increase in magnetic flux density waveform distortion. The increase in loss due to the increase in the waveform distortion is not negligible. However, in a wound core having a lap portion, it is difficult to eliminate the interlaminar magnetic flux transfer because of its structure. Accordingly, the present inventors have focused attention on the presence of closure domains specific to a strain-introduced magnetic domain refined material. The closure domains have a sheet thickness direction component. The inventors have therefore thought that the closure domains contribute to a reduction in the loss caused by the interlaminar magnetic flux transfer in the lap portion of the wound core and examined the relation between the amount of the closure domains and the loss (iron loss) in wound cores.

A unicore production apparatus manufactured by AEM was used to produce a wound core having two 45° bent portions at each corner portion and having a total weight of about 20 kg and a vertical length of 250 mm×a horizontal length of 250 mm×and a width of 100 mm. A step lap joining method was used for the wound core, and the lap lengths in the wound core were set to be constant. A plurality of wound cores with different lap lengths in the range of 0.5 mm to 40 mm were produced. The number of stacked sheets in each wound core was 200, and the number of turns of the primary coil and the number of turns of the secondary coil were each 40. The excitation conditions are as follows: a frequency of 50 Hz and a magnetic flux density of 1.7 T. The loss (iron loss) in each wound core was computed using a formula below. In the formula below, V₂(t) is the instantaneous value of the secondary voltage, and I₁(t) is the instantaneous value of the primary current. T is the period of the current-voltage waveforms.

$$\frac{1}{T} {\int }_{0}^{T} {V}_{2} ( t ) \times {I}_{1} ( t ) dt \qquad [ Math . 1 ]$$

A non-heat-resistant magnetic domain refined material was used as the material of the core. The magnetic domain refined material was subjected to magnetic domain refining treatment using a laser under the following treatment conditions. A single mode fiber laser was used. The output power was changed in the range of 500 W to 5 kW, and the diameter of the laser beam was changed in the range of 80 to 800 μm. The diameter of the laser beam on the surface of each steel sheet (magnetic domain refined material) was changed by changing the focal length. The scanning speed was 80 m/sec, and the beam spacing (the scanning spacing in the rolling direction (longitudinal direction) of the steel sheet) was 5 mm. In this case, evaluation was performed on the assumption that the diameter of the laser beam was equal to the width of the closure domains.

FIG. 7 shows the definitions for the closure domains in accordance with aspects of the present invention. The width of each closure domain (w in FIG. 7) was determined as follows. A closure domain on the surface of the steel sheet was observed by the Bitter method using a magnetic colloid easily attracted to portions with a large change in magnetization, and the width of the closure domain observed was measured. The depth of the closure domain (d in FIG. 7) was determined as follows. A cross section of the steel sheet was observed under a Kerr effect microscope, and the depth of a closure domain observed in a beam-irradiated portion was measured. To evaluate a building factor (B.F.) that is the ratio of the loss (iron loss) in a transformer to the iron loss in the core material, a single sheet magnetization measurement test using an H coil method described in JIS C 2566 was used to measure the iron loss in the core material.

FIG. 1 shows the relation between the building factor (B.F.) and an area of each closure domain in a cross-section that is taken in the longitudinal direction (the cross-sectional area of the closure domain). The cross-sectional area of the closure domain is determined as (the width μm of the closure domain×the depth μm of the closure domain) (see FIG. 7). As shown in FIG. 1, as the cross-sectional area of the closure domain increases, the building factor tends to be improved. As can be seen, when the cross-sectional area of the closure domain exceeds 7500 μm², the B.F. improving effect obtained is very high.

FIG. 2 shows the relation between the building factor (B.F.) and the lap length in the wound cores. This relation was examined with the cross-sectional area of the closure domain set to three different constant values. As can be seen, under all the conditions, an optimal lap length at which the building factor is small is present. When the cross-sectional area of the closure domain is within the range of the present invention (more than 7500 μm²) shown in FIG. 1, the range in which the building factor is good is broad, and the results show that the building factor is good when the lap length is in the range of 3.0 to 30 mm.

Next, the degrees of influence of factors that influence the cross-sectional area of each closure domain, i.e., (i) the width of the closure domain and (ii) the depth of the closure domain, were examined. The conditions when the cross-sectional area of the closure domain was 7800 μm² were used as reference conditions, and the relation between the building factor and the cross-sectional area of the closure domain was examined with one of the width of the closure domain and the depth of the closure domain changed variously (FIG. 3). The lap length of the wound core was set to be constant at 12 mm. When the cross-sectional area of the closure domain was 10000 μm² or more, increasing the depth of the closure domain was more effective in improving the building factor. The depth of the closure domain when the cross-sectional area of the closure domain was 10000 μm² was 60 μm. This shows that the depth of the closure domain is a factor having a larger influence on the building factor and that a closure domain depth of 60 μm or more is particularly effective.

The reason that the above results were obtained is unclear but may be as follows.

As found in FIG. 1, the building factor is improved by increasing the cross-sectional area of the closure domain. This may because, since each closure domain has a component perpendicular to the sheet surface (orthogonal to the sheet surface), the increase in the cross-sectional area of the closure domain contributes to a reduction in loss when a magnetic flux flows in a direction perpendicular to the sheet surface that differs from the direction of easy magnetization. Moreover, the closure domains have the effect of refining main magnetic domains to thereby reduce eddy-current loss. In lap joint portions, a magnetic flux flowing in the longitudinal direction of the sheet surface and also a magnetic flux flowing in a direction perpendicular to the sheet surface are present, and the magnetic flux distribution is non-uniform, so that magnetic flux density waveform distortion is large. It is inferred that increasing the cross-sectional area of each closure domain contributes also to reducing the increase in the eddy-current loss caused by the increased waveform distortion.

The reason for the increase in the building factor when the lap length is excessively small for the constant cross-sectional areas of the closure domain as found in FIG. 2 may be as follows. As the lap length decreases, the area for an interlaminar magnetic flux transferring in a direction perpendicular to the sheet surface decreases. In this case, instead of the amount of interlaminar magnetic flux transfer, the magnetic flux density increases in a lap portion. When the cross-sectional area of each closure domain is equal to or larger than a prescribed value, the magnetic flux can easily transfer in the direction perpendicular to the sheet surface. In this case, the increase in loss that occurs when the magnetic flux flows in the direction perpendicular to the sheet surface that differs from the direction of easy magnetization is reduced, and therefore the preferred range of the lap length increases. The reason for the increase in the building factor when the lap length is excessively large may be as follows. As the lap length increases, the area for interlaminar magnetic flux transfer increases, and the magnetic flux density decreases. However, the area of the lap joint portions in which the magnetic flux is non-uniform increases, so that the loss caused by waveform distortion increases. When the cross-sectional area of each closure domain is equal to or larger than a prescribed value, the increase in the iron loss caused by the waveform distortion is reduced, and this leads to an increase in the preferred range of the lap length.

The reason that the effect of improving the building factor is higher when the depth of the closure domain is increased than when the width of the closure domain is increased as shown in FIG. 3 may be as follows. The magnetic flux passes not only through the surfaces of the steel sheets but also through the inside of the steel sheets. Therefore, by forming the closure domains so as to extend deeper inside the steel sheets, the direction of the magnetic flux inside each steel sheet can be easily changed to a direction perpendicular to the sheet surface.

As can be seen from the above examination, by controlling the cross-sectional areas of the closure domains, it may be possible to significantly reduce the building factor. However, although the building factor can be reduced, the small building factor is useless when loss in the wound core (wound core loss) is large. The building factor is a value obtained by dividing the loss in the wound core (wound core loss) by the loss in the core material (iron loss). Therefore, to achieve a low building factor and a low wound core loss simultaneously, it is important that the loss (iron loss) in grain-oriented electrical steel sheets used as the material of the core be low.

The influence of the beam spacing on the loss in the core material was examined. A conventional 0.23 mm grain-oriented electrical steel sheet was prepared, and magnetic domain refining treatment was performed using a laser to obtain a core material. The magnetic flux density in the core material was B₈=1.96 T. The conditions for the magnetic domain refining treatment using the laser are as follows. The output power was changed from 100 W to 500 W, and the beam spacing in the longitudinal direction of the steel sheet was changed from 0.5 to 12 mm. The diameter of the laser beam was changed from 50 to 300 μm. The scanning speed was set to 10 m/sec. The other experimental methods and evaluation methods are the same as those described above. After the magnetic domain refining treatment, magnetization measurement was performed to evaluate iron loss W_{17/50} (W/kg). The beam spacing corresponds to the formation spacing of the closure domains (line spacing: D) in the longitudinal direction of the core material (see FIG. 7).

In FIG. 4, each closure domain has a cross-sectional area specified in accordance with aspects of the present invention. For steel sheets having closure domains with the same cross-sectional area, a large improvement is achieved when the line spacing exceeds 3 mm, and a large improvement is achieved when the line spacing is lower than 8 mm. It is therefore found that, when the line spacing is more than 3 mm and less than 8 mm, the loss in the wound core obtained is lowest. In the range in which the line spacing is 3 mm or less, the magnetic domain refining effect is saturated even when the line spacing is further reduced, and the eddy-current loss improving effect is unchanged. If the line spacing is excessively small, the hysteresis loss increases significantly. This may be a cause of the increase in iron loss. The reason that the iron loss increases when the line spacing is 8 mm or more is that an excessively large line spacing causes the magnetic domain refining effect to decrease and the eddy-current loss is not sufficiently reduced.

Aspects of the present invention are based on the above findings, and the summary of aspects of the present invention is as follows.

[1] A wound core which includes a flat portion and corner portions adjacent to the flat portion, the flat portion includes a lap portion and the corner portions includes bent portions, in which:
in the wound core, a non-heat-resistant magnetic domain refined material is used for at least a part of materials forming the wound core;
closure domains are formed in the non-heat-resistant magnetic domain refined material so as to extend in a direction intersecting a longitudinal direction of the non-heat-resistant magnetic domain refined material, an area of each of the closure domains in a cross section that is taken in the longitudinal direction being more than 7500 μm²; and
in the lap portion, the ratio of the number of lap joint portions having a lap length of from 3.0 mm to 30 mm to the total number of lap joint portions is 50% or more.

[2] The wound core according to [1], in which the closure domains have a depth of 60 μm or more.

[3] The wound core according to [1] or [2], in which the closure domains in the non-heat-resistant magnetic domain refined material are formed with a spacing of more than 3.0 mm and less than 8.0 mm in the longitudinal direction.

Aspects of the present invention can provide a wound core in which a non-heat-resistant magnetic domain refined material is used for at least a part of a materials forming the wound core and which has a high iron loss reducing effect.

In particular, aspects of the present invention can provide a wound core in which grain-oriented electrical steel sheets subjected to non-heat-resistant (strain-introduced) magnetic domain refining treatment to reduce iron loss significantly are used as a material of the core and which has a low building factor and a low loss while the low-iron loss property of the material is utilized as much as possible. According to aspects of the present invention, the occurrence of large loss (iron loss) in a lap portion can be reduced particularly in a unicore or duocore type wound core, and the loss in the wound core obtained can be small.

### BRIEF DESCRIPTION OF THE DRAWINGS

FIG. 1 A graph showing the relation between a building factor (B.F.) and the area of a closure domain in a cross section that is taken in the longitudinal direction (the cross-sectional area of the closure domain).

FIG. 2 A graph showing the relation between the building factor (B.F.) and a lap length in wound cores.

FIG. 3 A graph showing the results of examination of the relation between the building factor (B.F.) and the cross-sectional area of each closure domain, the examination being performed with one of the width of the closure domain and the depth of the closure domain changed variously.

FIG. 4 A graph showing the relation between core material iron loss and a line spacing.

FIG. 5 A schematic illustration (side view) showing the structure of a wound core.

FIG. 6 Schematic illustrations showing joining methods (step lap joining and overlap joining) in wound cores.

FIG. 7 A schematic illustration illustrating the definitions for closure domains.

FIG. 8 Schematic illustrations showing examples of a wound core in which a non-heat-resistant magnetic domain refined material is used at least for a part thereof.

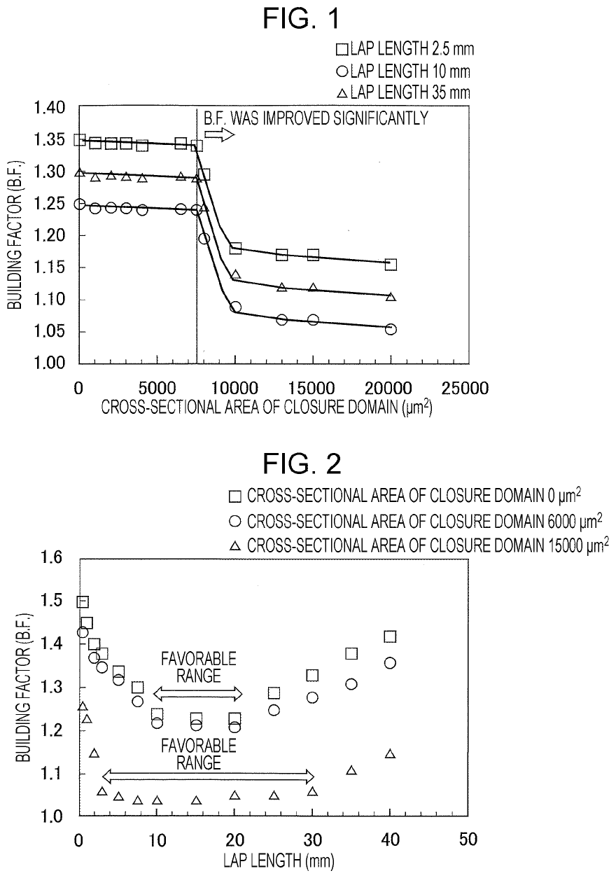

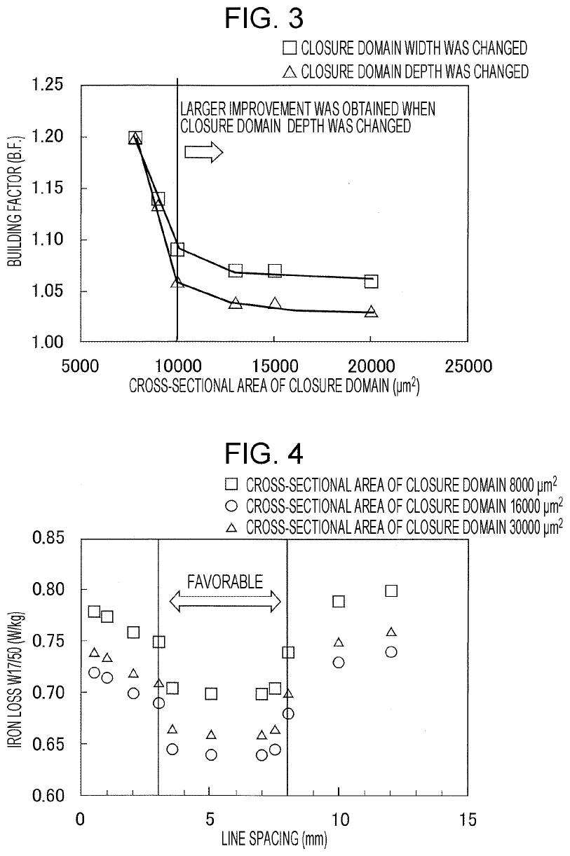

### DETAILED DESCRIPTION OF EMBODIMENTS OF THE INVENTION

The structure of the wound core according to aspects of the present invention will be specifically described.

### <Wound Core>

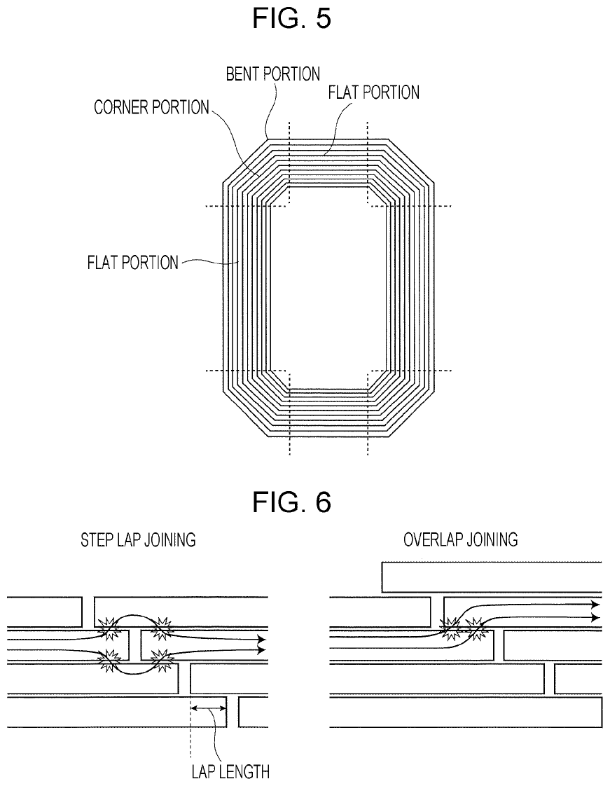

The wound core has bent portions in corner portions and a lap portion in a flat portion and is of the type that requires no strain relief annealing. For example, the wound core is effective for a unicore type wound core and a duocore type wound core. In a Tranco core type wound core that requires strain relief annealing, the closure domains, which are the feature of aspects of the present invention, are annihilated by the strain relief annealing, and the effects according to aspects of the present invention are not obtained. FIG. 5 schematically illustrates a side view of the wound core. Straight lines are drawn to perpendicular directions of stacking so as to pass through end points of bending of the innermost steel sheet. These straight lines are used as boundaries between corner portions and flat portions. As shown in FIG. 5, the wound core according to aspects of the present invention includes the flat portions and the corner portions adjacent to the flat portions. In the wound core, the flat portions and the corner portions are arranged alternately in a continuous manner. The wound core has a substantially rectangular shape in a side view. The wound core according to aspects of the present invention has a lap portion in a flat portion and bent portions in the corner portions. When the wound core is of the unicore type, one of the four flat portions has a lap portion. When the wound core is of the duocore type, two of the four flat portions have respective lap portions. Each lap portion has joint portions (lap joint portions) that are formed by stacking steel sheets formed of a core material in their thickness direction so as to overlap each other by a lap length.

Generally, an overlap-type joining method (overlap joining) or a step lap-type joining method (step lap joining) shown in FIG. 6 is used. The effects according to aspects of the present invention can be obtained with any of these methods. However, the effects obtained by applying aspects of the present invention are higher when the number of occurrences of interlaminar magnetic flux transfer in a direction perpendicular to the sheet surface is larger. In the overlap type and the step lap type shown in FIG. 6, the number of occurrences of interlaminar magnetic flux transfer is larger in the step lap type, and therefore the effects according to aspects of the present invention are higher when aspects of the invention is applied to the step lap type core. In a unicore, one lap joint portion is present in one turn. In a duocore, two lap joint portions are present in one turn. Therefore, the effects according to aspects of the invention can be more effectively utilized when aspects of the invention is applied to the duocore.

In a wound core, if the lap length in lap joint portions (see FIG. 6) is less than 3.0 mm, iron loss deterioration due to magnetic flux concentration is large, and the effects according to aspects of the invention are not obtained sufficiently. If the lap length is more than 30 mm, the influence of the increase in magnetic flux density waveform distortion due to the increase in the area of non-uniform magnetic flux regions is large, and the effects according to aspects of the invention are also not obtained sufficiently. Therefore, the lap length range in which the effects according to aspects of the invention can be utilized is from 3.0 mm to 30 mm. Generally, in one wound core, the lap lengths are constant or substantially constant. However, aspects of the present invention are effective for a wound core in which the lap lengths are not constant. Even in this case, the effects according to aspects of the invention can be utilized when the ratio of the number of lap joint portions with a lap length of from 3.0 mm to 30 mm to the total number of lap joint portions [(the number of lap joint portions with a lap length of from 3.0 mm to 30 mm/the total number of lap joint portions)×100] is 50% or more. The above ratio is preferably 75% or more.

No particular limitation is imposed on the method for producing the wound core, and, for example, any known method may be used. More specifically, a unicore production apparatus manufactured by AEM is used. In this case, design sizes are inputted into the production apparatus, and steel sheets are sheared and bent into the respective design sizes. The machined steel sheets (raw material sheets) are stacked (stacked in the thickness direction), and the wound core described above can thereby be produced. In accordance with aspects of the present invention, when the wound core is produced, the requirement for the lap portion is controlled so as to fall within the range according to aspects of the present invention. So long as the above requirement is met, no particular limitation is imposed on the other factors such as the size of the core, the bending angles of the bent portions in the corner portions, and the number of bent portions.

In the wound core according to aspects of the present invention, it is necessary that a prescribed non-heat-resistant (strain-introduced) magnetic domain refined material be used for at least a part of materials forming the wound core. The phrase “the prescribed non-heat-resistant magnetic domain refined material is used for at least a part of materials forming the wound core” means that at least one turn (one layer) of core materials forming the wound core is formed of the prescribed non-heat-resistant magnetic domain refined material. This is because, to utilize the effects according to aspects of the invention, it is necessary to use the prescribed non-heat-resistant magnetic domain refined material in at least one lap joint portion in the wound core.

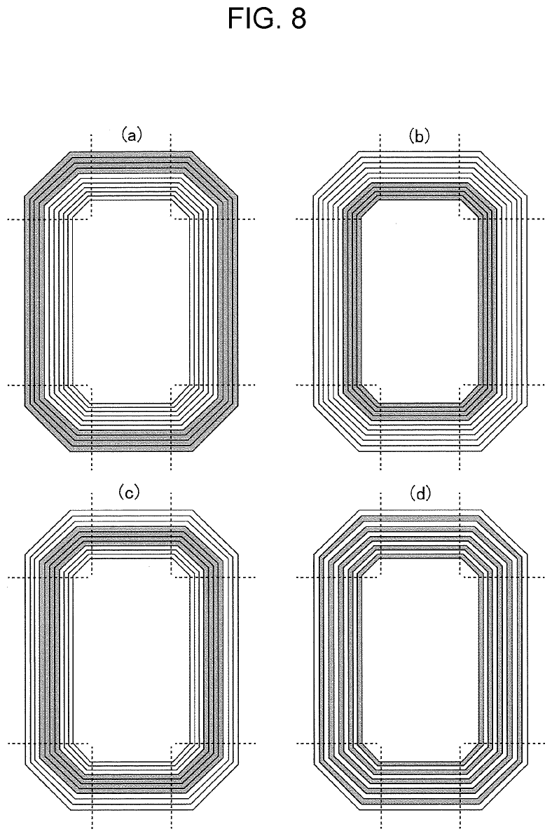

In the wound core according to aspects of the present invention, no particular limitation is imposed on the positions of turns (layers) for which the prescribed non-heat-resistant magnetic domain refined material is used. For example, as shown in FIG. 8, one or more turns including the outermost layer of the wound core may be formed of the prescribed non-heat-resistant magnetic domain refined material (FIG. 8(a)). Alternatively, one or more turns including the innermost layer of the wound core may be formed of the prescribed non-heat-resistant magnetic domain refined material (FIG. 8(b)), or one or more turns inside the wound core may be formed of the prescribed non-heat-resistant magnetic domain refined material (FIG. 8(c)). When a plurality of turns are formed of the prescribed non-heat-resistant magnetic domain refined material, the magnetic domain refined material may be used for consecutively stacked layers (FIG. 8(a) to (c)) or may not be used for consecutively stacked layers (FIG. 8(d)). In FIG. 8, grey turns indicate the prescribed non-heat-resistant magnetic domain refined material.

In the wound core according to aspects of the present invention, the larger the amount of the prescribed non-heat-resistant magnetic domain refined material used, the higher the effects according to aspects of the invention. It is therefore recommended that the ratio of the number of stacked sheets (the number of stacked layers) for which the prescribed non-heat-resistant magnetic domain refined material is used to the total number of stacked sheets (the total number of stacked layers) in the wound core (the wound iron core) be preferably 50% or more and more preferably 75% or more. When the ratio of the number of stacked layers for which the prescribed non-heat-resistant magnetic domain refined material is used is 100% in the wound core produced (i.e., the prescribed non-heat-resistant magnetic domain refined material is used for all the stacked layers of the wound core), the effects according to aspects of the invention obtained can be maximized.

### <Non-Heat-Resistant Magnetic Domain Refined Material>

The non-heat-resistant magnetic domain refined material in accordance with aspects of the present invention is prepared by subjecting the surface of a grain-oriented electrical steel sheet to magnetic domain refining treatment for introducing strain (microstrain) using laser beam, electron beam, or plasma irradiation. No particular limitation is imposed on the grain-oriented electrical steel sheet. For example, any grain-oriented electrical steel sheet obtained by a routine method can be used. The higher the degree of preferred orientation of the grain-oriented electrical steel sheet, the higher the magnetic domain refining effect. Therefore, from the viewpoint of reducing iron loss, the magnetic flux density B₈ is preferably 1.92 T or more.

Generally, a forsterite coating is formed on the surface of the grain-oriented electrical steel sheet but may not be formed. If necessary, an insulating coating may be formed on the surface of the grain-oriented electrical steel sheet used. The insulating coating means a coating (tension coating) that imparts tension to the steel sheet in order to reduce iron loss. Examples of the tension coating include inorganic-based coatings containing silica and ceramic coatings formed by physical vapor deposition, chemical vapor deposition, etc.

### [Magnetic Domain Refining Treatment]

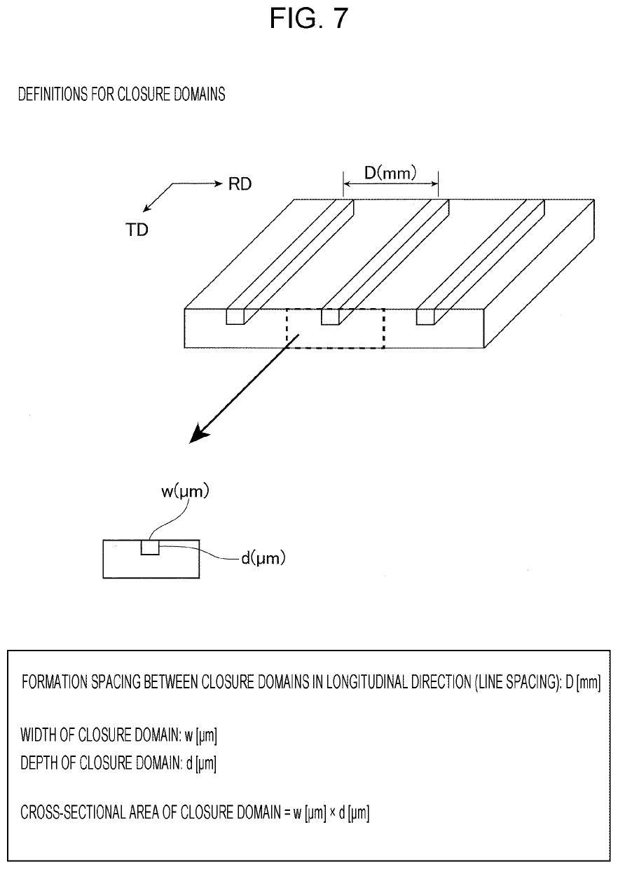

In accordance with aspects of the present invention, the non-heat-resistant magnetic domain refined material subjected to magnetic domain refining treatment is used for at least a part of the wound core material. No particular limitation is imposed on the magnetic domain refining treatment method. For example, a well-known method using a laser, plasma, an electron beam, etc. may be used. No particular limitation is imposed on the treatment conditions. For example, well-known treatment conditions may be used for the treatment. As for the treatment conditions, the irradiation direction (the extending direction of the closure domains formed by irradiation) is a direction intersecting the rolling direction of the non-heat-resistant magnetic domain refined material (the longitudinal direction, i.e., the RD direction in FIG. 7). The irradiation direction is preferably a direction inclined by 60° to 90° with respect to the rolling direction. The direction inclined by 90° corresponds to a direction orthogonal to the rolling direction (i.e., the TD direction in FIG. 7). Preferably, the output power is 50 W to 5 kW, and the scanning speed is 10 m/sec or more from the viewpoint of productivity.

One feature of the magnetic domain refining treatment is that the area of each closure domain in a cross section that is taken in the longitudinal direction (the cross-sectional area of each closure domain) is set to more than 7500 μm². If the cross-sectional area of each closure domain is smaller than 7500 μm², the amount of the closure domains is insufficient, so that the effects according to aspects of the invention such as an increase in optimal lap length and a reduction in loss in the lap portion cannot be obtained. The cross-sectional area of each closure domain is more preferably 10000 μm² or more.

No particular limitation is imposed on the line spacing (the spacing between the closure domains formed). To achieve the most important object, i.e., to reduce the loss in the wound core as much as possible, the line spacing in the non-heat-resistant magnetic domain refined material in the longitudinal direction is preferably more than 3.0 mm and less than 8.0 mm. When the depth of the closure domains is 60 μm or more, the effects according to aspects of the invention can be obtained more easily. No particular limitation is imposed on the method for forming deeper closure domains. It is preferable that the beam diameter is reduced to increase the energy density. From the viewpoint of forming deeper closure domains, the beam diameter is preferably 0.2 mm or less.

### EXAMPLES

Next, aspects of the present invention will be described specifically on the basis of Examples. The following Examples show preferred examples of the invention, and the invention is not limited to these Examples. Embodiments of the invention can be appropriately modified within the range suitable for the gist of the invention, and all the modifications are included in the technical range of the invention.

### Example 1

Grain-oriented electrical steel sheets having the same magnetic flux density (B₈=1.92 T) were prepared and irradiated with a laser or electron beam to perform magnetic domain refining treatment. The irradiation conditions (output power, irradiation line spacing, deflection speed, and beam diameter) are shown in Table 1. Then the iron loss W_{17/50} of the material, the cross-sectional area of each closure domain, the depth of the closure domains, and the width of the closure domains were derived.

The grain-oriented electrical steel sheets subjected to the non-heat-resistant magnetic domain refining treatment were used as core materials to produce wound cores. The weight of each wound core was about 40 kg, and its capacity was 30 kVA. Each wound core was a unicore having a lap portion in one flat portion (one lap joint portion in one turn) and bent portions in corner portions or a duocore having lap portions in two flat portions (two lap joint portions in one turn) and bent portions in corner portions. The lap lengths in each wound core were constant. The unicores and the duocores were each produced by machining the grain-oriented electrical steel sheets such that the bent portions had an angle of 45° and then stacking the resulting sheets. Specifically, wound cores having different lap lengths shown in Table 2 were produced. Then the loss W_{17/50} of each of the produced wound cores was measured.

As shown in Table 1, material A was not subjected to the magnetic domain refining treatment. However, materials B to P were subjected to the magnetic domain refining treatment, and the iron loss in each of these materials was smaller. In materials B, C, F to H, K to M, and P having a line spacing of more than 3.0 mm and less than 8.0 mm, the effect of reducing the material iron loss was higher than that in materials D, I, and N having a line spacing of 3.0 mm or less and that in materials E, J, and O having a line spacing of 8.0 mm or more.

TABLE 1

| | | | | | | | | Cross- | |
|---|---|---|---|---|---|---|---|---|---|
| | | | | | | | | sectional | |
| | | | | | | Width of | Depth of | area of | |
| | | | Deflection | Beam | spacing | closure | closure | each closure | Iron loss |
| | | Power | speed | diameter | Line | domains | domains | domain | W_{17/50} |
| Material | Type | (W) | (m/sec) | (mm) | (mm) | (μm) | (μm) | (μm²) | (W/kg) |
| A | No magnetic domain refining treatment | | | | | | | | 0.83 |
| B | Laser | 100 | 10 | 0.12 | 5 | 120 | 40 | 4800 | 0.76 |
| C | | 250 | 10 | 0.12 | 5 | 120 | 90 | 10800 | 0.73 |
| D | | 250 | 10 | 0.12 | 2 | 120 | 90 | 10800 | 0.80 |
| E | | 250 | 10 | 0.12 | 10 | 120 | 90 | 10800 | 0.80 |
| F | | 500 | 10 | 0.20 | 5 | 200 | 50 | 10000 | 0.76 |
| G | Electron | 250 | 40 | 0.20 | 7 | 200 | 35 | 7000 | 0.76 |
| H | beam | 500 | 40 | 0.20 | 7 | 200 | 70 | 14000 | 0.75 |
| I | | 500 | 40 | 0.20 | 1.5 | 200 | 70 | 14000 | 0.80 |
| J | | 500 | 40 | 0.20 | 12 | 200 | 70 | 14000 | 0.80 |
| K | | 500 | 40 | 0.40 | 7 | 400 | 40 | 16000 | 0.76 |
| L | | 1000 | 100 | 0.10 | 6 | 100 | 40 | 4000 | 0.76 |
| M | | 2500 | 100 | 0.10 | 6 | 100 | 120 | 12000 | 0.70 |
| N | | 2500 | 100 | 0.10 | 0.5 | 100 | 120 | 12000 | 0.75 |
| O | | 2500 | 100 | 0.10 | 9 | 100 | 120 | 12000 | 0.75 |
| P | | 2500 | 200 | 0.10 | 6 | 100 | 40 | 4000 | 0.76 |

Underlines mean outside the range of the invention.

As shown in Table 2, in wound cores Nos. 1 and 2 produced using only material A not subjected to the magnetic domain refining treatment, loss in the joint portions was very large, and the wound core loss and the building factor were also very large. Comparison between No. 1 and No. 2 shows that the wound core loss and the building factor are larger in the duocore in No. 2. This is because the number of lap joint portions is larger in the duocore. In Nos. 6, 7, 17, 18, 28, and 29, the wound core loss and the building factor are larger than those in the wound cores in the Inventive Examples. This is because the lap length of the lap joint portions is outside the range of the invention. In Nos. 3, 14, and 25 also, the wound core loss and the building factor are large. This is because the cross-sectional area of each of the closure domains formed in the material is outside the range of the invention.

Nos. 11, 12, 22, 23, 30, and 31 are Inventive Examples. In Nos. 4, 11, and 12, the building factors are the same and good, but the wound core loss is larger in Nos. 11 and 12 than in No. 4. In Nos. 15, 22, and 23, the building factors are the same and good, but the wound core loss is larger in Nos. 22 and 23 than in No. 15. In Nos. 26, 30, and 31, the building factors are the same and good, but the wound core loss is larger in Nos. 30 and 31 than in No. 26. This is because the line spacings in the materials are not optimized. In each of the wound cores in Inventive Examples Nos. 8, 9, 10, 19, 20, and 21, the material outside the range of the invention (material A) was used for a part of the material forming the wound core. In these wound cores, the building factor is higher than those in the Inventive Examples in which all the material forming the wound core is in the range of aspects of the invention. In Nos. 13 and 24, the building factor tends to be slightly higher than those in Nos. 4, 5, 15, 16, 26, and 27 having optimal building factors. In particular, in No. 24, although the volume of the closure domains is sufficient, the building factor tends to be slightly larger than the optimal building factors. This may be because the depth of the closure domains is outside the preferred range. In Nos. 4, 5, 15, 16, 26, and 27 produced under the most preferred conditions, the building factors are most preferred, and the absolute values of the wound core loss are the best.

TABLE 2

| | | | | Ratio of lap joint | Wound core | | |
|---|---|---|---|---|---|---|---|
| | | | Lap | portions with lap length | loss | | |
| | Material | Core | length | of from 3.0 mm to | W_{17/50} | Building | |
| No. | ratio*¹ | type | (mm) | 30 mm *² (%) | (W/kg) | factor | Remarks |
| 1 | A 100% | Unicore | 10 | 100 | 1.162 | 1.40 | Comparative |
| | | | | | | | Example |
| 2 | A 100% | Duocore | 10 | 100 | 1.289 | 1.55 | Comparative |
| | | | | | | | Example |
| 3 | B 100% | Unicore | 10 | 100 | 1.049 | 1.38 | Comparative |
| | | | | | | | Example |
| 4 | C 100% | Unicore | 12 | 100 | 0.781 | 1.07 | Inventive Example |
| 5 | C 100% | Duocore | 12 | 100 | 0.796 | 1.09 | Inventive Example |
| 6 | C 100% | Unicore | 2.5 | 0 | 0.920 | 1.26 | Comparative |
| | | | | | | | Example |
| 7 | C 100% | Unicore | 40 | 0 | 0.861 | 1.18 | Comparative |
| | | | | | | | Example |
| 8 | A 80% C | Unicore | 10 | 100 | 0.956 | 1.18 | Inventive Example |
| | 20% | | | | | | |
| 9 | A 40% C | Unicore | 10 | 100 | 0.878 | 1.14 | Inventive Example |
| | 60% | | | | | | |
| 10 | A 20% C | Unicore | 10 | 100 | 0.825 | 1.10 | Inventive Example |
| | 80% | | | | | | |
| 11 | D 100% | Unicore | 10 | 100 | 0.856 | 1.07 | Inventive Example |
| 12 | E 100% | Unicore | 10 | 100 | 0.856 | 1.07 | Inventive Example |
| 13 | F 100% | Unicore | 10 | 100 | 0.844 | 1.11 | Inventive Example |
| 14 | G 100% | Unicore | 8 | 100 | 1.026 | 1.35 | Comparative |
| | | | | | | | Example |
| 15 | H 100% | Unicore | 8 | 100 | 0.803 | 1.07 | Inventive Example |
| 16 | H 100% | Duocore | 8 | 100 | 0.818 | 1.09 | Inventive Example |
| 17 | H 100% | Unicore | 1 | 0 | 0.975 | 1.30 | Comparative |
| | | | | | | | Example |
| 18 | H 100% | Unicore | 35 | 0 | 0.938 | 1.25 | Comparative |
| | | | | | | | Example |
| 19 | A 80% H | Unicore | 8 | 100 | 0.961 | 1.18 | Inventive Example |
| | 20% | | | | | | |
| 20 | A 40% H | Unicore | 8 | 100 | 0.923 | 1.14 | Inventive Example |
| | 60% | | | | | | |
| 21 | A 20% H | Unicore | 8 | 100 | 0.843 | 1.10 | Inventive Example |
| | 80% | | | | | | |
| 22 | 100% | Unicore | 8 | 100 | 0.856 | 1.07 | Inventive Example |
| 23 | J 100% | Unicore | 8 | 100 | 0.856 | 1.07 | Inventive Example |
| 24 | K 100% | Unicore | 8 | 100 | 0.851 | 1.12 | Inventive Example |
| 25 | L 100% | Duocore | 16 | 100 | 1.120 | 1.48 | Comparative |
| | | | | | | | Example |
| 26 | M 100% | Duocore | 16 | 100 | 0.763 | 1.09 | Inventive Example |
| 27 | M 100% | Unicore | 16 | 100 | 0.749 | 1.07 | Inventive Example |
| 28 | M 100% | Duocore | 0.5 | 0 | 0.987 | 1.41 | Comparative |
| | | | | | | | Example |
| 29 | M 100% | Duocore | 50 | 0 | 0.931 | 1.33 | Comparative |
| | | | | | | | Example |
| 30 | N 100% | Duocore | 16 | 100 | 0.818 | 1.09 | Inventive Example |
| 31 | O 100% | Duocore | 16 | 100 | 0.818 | 1.09 | Inventive Example |
| 32 | P 100% | Duocore | 16 | 100 | 1.071 | 1.41 | Comparative |
| | | | | | | | Example |

*¹The ratio of the number of stacked material sheets to the total number of stacked sheets in the wound core.
*² (The number of lap joint portions with a lap length of from 3.0 mm to 30 mm/the total number of lap joint portions) × 100
Underlines mean outside the range of the invention.

### Example 2

Unicores having the same shape as that in Example 1 except for the lap lengths were produced using materials A, C, H, and M in Example 1. Unlike in Example 1, in Example 2, different lap lengths in value ranges in “Lap lengths changed for different layers” shown in Table 3 were used for different turns (different layers). In some wound cores (in which the value indicated in “Lap lengths changed for different layers” shown in Table 3 is constant), the lap length was set to be constant (fixed) The ratio of the number of lap joint portions with a lap length of from 3.0 mm to 30 mm (the ratio of the number of lap joint portions with a lap length of from 3.0 mm to 30 mm to the total number of lap joint portions), which is important in accordance with aspects of the present invention, is shown in Table 3. As can be seen from the results in Table 3, when material A not subjected to the magnetic domain refining treatment was used, the building factor was very high, irrespective of the ratio of the number of lap joint portions with a lap length of from 3.0 mm to 30 mm. However, when materials C, H, and M subjected to the prescribed magnetic domain refining treatment were used, the building factor was good when the ratio of the number of lap joint portions with a lap length of from 3.0 mm to 30 mm was in the range according to aspects of the invention.

TABLE 3

| | | | Lap lengths | Ratio of lap joint | Wound | | |
|---|---|---|---|---|---|---|---|
| | | | changed | portions with lap | core | | |
| | | | for different | length of from | loss | | |
| | Material | | layers*² | 3.0 mm to 30 | W_{17/50} | Building | |
| No. | ratio*¹ | Core type | (mm) | mm*³ (%) | (W/kg) | factor | Remarks |
| 41 | A 100% | Unicore | 10 | 100 | 1.166 | 1.40 | Comparative Example |
| 42 | A 100% | Unicore | 1~40 | 80 | 1.166 | 1.40 | Comparative Example |
| 43 | A 100% | Unicore | 1~40 | 60 | 1.168 | 1.41 | Comparative Example |
| 44 | A 100% | Unicore | 1~40 | 30 | 1.170 | 1.41 | Comparative Example |
| 45 | A 100% | Unicore | 1~40 | 10 | 1.172 | 1.41 | Comparative Example |
| 46 | C 100% | Unicore | 4 | 100 | 0.788 | 1.08 | Inventive Example |
| 47 | C 100% | Unicore | 0.5~5 | 80 | 0.792 | 1.08 | Inventive Example |
| 48 | C 100% | Unicore | 0.5~5 | 50 | 0.802 | 1.10 | Inventive Example |
| 49 | C 100% | Unicore | 0.5~5 | 30 | 0.886 | 1.21 | Comparative Example |
| 50 | C 100% | Unicore | 0.5~5 | 10 | 0.931 | 1.24 | Comparative Example |
| 51 | H 100% | Unicore | 25 | 100 | 0.821 | 1.09 | Inventive Example |
| 52 | H 100% | Unicore | 20~40 | 80 | 0.825 | 1.10 | Inventive Example |
| 53 | H 100% | Unicore | 20~40 | 60 | 0.830 | 1.11 | Inventive Example |
| 54 | H 100% | Unicore | 20~40 | 30 | 0.901 | 1.20 | Comparative Example |
| 55 | H 100% | Unicore | 20~40 | 10 | 0.920 | 1.23 | Comparative Example |
| 56 | M 100% | Unicore | 10 | 100 | 0.763 | 1.09 | Inventive Example |
| 57 | M 100% | Unicore | 1~40 | 75 | 0.768 | 1.10 | Inventive Example |
| 58 | M 100% | Unicore | 1~40 | 50 | 0.779 | 1.11 | Inventive Example |
| 59 | M 100% | Unicore | 1~40 | 30 | 0.850 | 1.21 | Comparative Example |
| 60 | M 100% | Unicore | 1~40 | 10 | 0.880 | 1.26 | Comparative Example |

*¹The ratio of the number of stacked material sheets to the total number of stacked sheets in the wound core.
*²Each value range means that the lap lengths for different layers were changed within the range.
*³(The number of lap joint portions with a lap length of from 3.0 mm to 30 mm/the total number of lap joint portions) × 100
Underlines mean outside the range of the invention.

1. A wound core comprising a flat portion and corner portions adjacent to the flat portion, the flat portion including a lap portion, the corner portions including bent portions, wherein:
in the wound core, a non-heat-resistant magnetic domain refined material is used for at least a part of materials forming the wound core;
closure domains are formed in the non-heat-resistant magnetic domain refined material so as to extend in a direction intersecting a longitudinal direction of the non-heat-resistant magnetic domain refined material, an area of each of the closure domains in a cross section that is taken in the longitudinal direction being more than 7500 μm²; and
in the lap portion, the ratio of the number of lap joint portions having a lap length of from 3.0 mm to 30 mm to the total number of lap joint portions is 50% or more.

2. The wound core according to claim 1, wherein the closure domains have a depth of 60 μm or more.

3. The wound core according to claim 1, wherein the closure domains in the non-heat-resistant magnetic domain refined material are formed with a spacing of more than 3.0 mm and less than 8.0 mm in the longitudinal direction.

4. The wound core according to claim 2, wherein the closure domains in the non-heat-resistant magnetic domain refined material are formed with a spacing of more than 3.0 mm and less than 8.0 mm in the longitudinal direction.
